(19) United States
(12) Patent Application Publication
(10) Pub. No.: US 2013/0320263 A1
(43) Pub. Date: Dec. 5, 2013

(54) SURFACTANT EFFECTS ON EFFICIENCY ENHANCEMENT OF LUMINESCENT PARTICLES

(71) Applicant: Rutgers, The State University of New Jersey, New Brunswick, NJ (US)

(72) Inventors: Richard E. Riman, Belle Mead, NJ (US); Mei-Chee Tan, Singapore (SG)

(21) Appl. No.: 13/904,795

(22) Filed: May 29, 2013

Related U.S. Application Data
(60) Provisional application No. 61/652,374, filed on May 29, 2012.

(51) Int. Cl. C09K 11/77

(52) U.S. Cl. CPC C09K 11/7773
USPC 252/301.36

(57) ABSTRACT

Disclosed are luminescent compositions having luminescent particles coated by a surface capping agent. Luminescent particles include rare earth doped phosphors, semiconductor quantum dots, and organic phosphors. Surfactants include macromolecules, polypeptides, polysaccharides, and polymers. Rare earth doped phosphors have host compositions and rare earth dopants, wherein the host compositions include NaYF₄, LaF₃, YF₃, CeF₃, CaF₂, CsCdBr₃, and Y₂O₃, and wherein the rare earth dopants include Cs, Pr, Nd, Sm, Er, Gs, Tb, Dy, Ho, Er, Tim, Yb, and combinations of two or more of these. The refractive index mismatch of the luminescent compositions and surrounding medium is less than about 0.1. Also disclosed are methods of making the luminescent compositions, luminescent devices and displays containing the luminescent compositions, uses of the luminescent compositions in particle imaging velocimetry, and uses of the luminescent compositions as contrast agents for disease monitoring.

### CROSS-REFERENCE TO RELATED APPLICATIONS

This application claims the benefit of U.S. Provisional Application Ser. No. 61/652,374, filed May 29, 2012, which is hereby incorporated by reference.

### STATEMENT REGARDING FEDERAL FUNDED RESEARCH

This invention was made with government support under grant number ONR-N00014-08-1-0131 awarded by the Defense Advanced Research Projects Agency. The government has certain rights in the invention.

### FIELD OF THE INVENTION

The present invention relates to the field of surface-capped (i.e., surfactant coated) luminescent particles.

### BACKGROUND OF THE INVENTION

Luminescent materials emit over a wide range of electromagnetic radiation such as the x-ray, ultraviolet, visible, infrared regions upon suitable excitation or supply of energy. The type of luminescence can be distinguished based on the type of excitation energy, for example, cathodoluminescence, photoluminescence, x-ray luminescence, electroluminescence, sonoluminescence, chemoluminescence, bioluminescence and tribioluminescence. Luminescent materials can be broadly classified as organic phosphors, inorganic ceramic materials doped with optically-active ions, and semiconductor quantum dots with size-dependent quantum confined states (or band gaps).

Infrared-to-visible rare earth doped upconversion phosphors that convert multiple photons of lower energy to higher energy photons offer a wide range of technological applications in solid-state lasers, three-dimensional flat-panel displays, energy-efficient photovoltaic devices, biomedical imaging and photodynamic therapy applications. The absorption and emission properties of rare-earth doped materials can be tailored by controlling the local environment, such as site symmetry, crystal field strength and electron-phonon interaction strength of rare-earth dopants.

Reduced optical efficiencies of phosphors can be attributed to reflectance losses at the particle-air interface. Fresnel reflection (i.e., principle for total internal reflection) occurs at any medium boundary where the refractive index changes from low to high, resulting in a portion of light being reflected, back. The reflectance loss of the incident excitation light is typically negligible because the refractive index of air is less than that of a typical phosphor particle. The reflectance at the boundary R can be estimated using the following equation:

$$R ( \% ) = \frac{{( {n}_{1} - {n}_{2} )}^{2}}{{( {n}_{1} + {n}_{2} )}^{2}} \times 100 \%$$

where n₁ and n₂ are the refractive indices of the core light-emitting phosphor particle and surrounding medium (i.e., air), respectively.

The large refractive index mismatch between the core light-emitting phosphor particle and surrounding medium leads to high reflectance losses of the emitted light. The portion of emitted light that is back reflected is most likely reabsorbed. While some of the reabsorbed light is re-emitted, another fraction of the reabsorbed portion is lost through either lower photon energy or non-radiative emissions. Consequently, the high reflective loss leads to significant reduction of emitted light from the light-emitting phosphor core.

Accordingly, there is a need in the art for phosphor compositions exhibiting reduced refractive index mismatches between the core light-emitting phosphor particles the surrounding medium. The present invention addresses these needs, among others.

### SUMMARY OF THE INVENTION

This invention is based, at least in part, on the utilization of surface capping agents that reduce the refractive index mismatch between luminescent particles and the surrounding medium into which they emit light.

In certain embodiments, the present invention provides a luminescent composition including one or more luminescent particles, wherein the luminescent particles are coated by a surface capping agent. The luminescent particles of the present invention include, without limitation, inorganic ceramic materials doped with optically-active ions (i.e, rare earth doped phosphors), semiconductor quantum dots, and organic phosphors. Semiconductor quantum dots suitable for use with the present invention include, without limitation, PbS, PbSe, InP, InAs, CdS, CdSe, ZnS, ZnSe, and combinations of two or more of these.

In certain embodiments of the invention, rare earth doped phosphors suitable for use with the present invention include a host and a rare earth dopant. Suitable host compounds include oxides or halides, such as NaYF₄, LaF₃, YF₃, CeF₃, CaF₂, CsCdBr₃, Y₂O₃, and combinations of two or more of these. Suitable rare earth dopants include Ce, Pr, Nd, Sm, Eu, Gd, Tb, Dy, Ho, Er, Tm, Yb, and combinations of two or more of these. In certain preferred embodiments, the rare earth dopant is made up of a dopant scheme including, without limitation, Nd—Tm, Yb—Er, Tb—Tm, Tb—Pr, Yb—Ho, Yb—Er—Tm, Yb—Pr—Tm—Er, Yb—Ho—Pr, and Yb—Ho—Tm.

In certain embodiments of the invention, the surface capping agent comprises a surfactant. Surfactants suitable for use with the present invention include, without limitation, macromolecules, polypeptides, polysaccharides, polymers, and combinations of two or more of these. The macromolecules include, without limitation, deoxyribonucleic acid, ribonucleic acid proteins, glycoproteins, and combinations of two or more of these. In certain embodiments, suitable surfactants include pol-L-lysine, poly-d-lysine, poly-ethylene glycol, poly-2-hydroxyethyl apartamide, poly(d,l-lactide-co-glycolide, poly(methyl methacrylate), poly(N-isopropylacrylamide), poly(admidoamine), polyethyleneimine, poly lactic acid, polycarpolactone, dextran, alginates, chitosan, transferrin, collagenase, gelatin, and combinations of two or more of these. In certain preferred embodiments of the present invention, the surfactant includes trioctylphosphine, polyethylene glycol monooleate, polyvinyl-pyrrolidone, polyvinyl-alcohol, polyethylene glycol dioleate, polyol esters, oleic acid, olelamine, and combinations of two or more of these.

Certain preferred embodiments of the present invention provide a luminescent composition including a hexagonal phase NaYF₄ doped with Yb—Er, wherein the luminescent particle is coated by a surface capping agent. The surface capping agent comprises a surfactant selected from the group consisting of triocylphosphine, polyethylene glycol monooleate, polyvinyl-pyrrolidone, and combinations of two or more of these. In certain preferred embodiments, the surfactant is polyvinyl-pyrrolidone.

The luminescent compositions of the present invention exist in a surrounding medium. In certain embodiments, the surrounding medium consists essentially of air. In certain preferred embodiments, the refractive index mismatch of the luminescent composition and the surrounding medium is less than about 0.1, and more preferably less than about 0.01, and even more preferably less than about 0.01.

### BRIEF DESCRIPTION OF THE FIGURES

FIG. 1 illustrates the molecular structure of surface capping agents used for hydrothermal synthesis of hexagonal-phase NaYF₄:Yb—Er.

FIG. 2 illustrates XRD profiles of NaYF₄:Yb—Er particles synthesized with different surface capping agents compared with the unmodified particles.

FIG. 3 illustrates elemental composition of NaYF₄:Yb—Er particles synthesized using different surface capping agents compared with the unmodified particles.

FIG. 4 illustrates SEM micrographs of NaYF₄:Yb—Er particles synthesized with different surface capping agents compared with the unmodified particles.

FIG. 5 illustrates the effects of surface capping agents on infrared-to-visible upconversion emissions of as-synthesized NaYF₄:Yb—Er particles.

FIG. 6(a) illustrates a schematic representation of reflectance losses due to reflective index mismatches between an unmodified luminescent particle and its surrounding medium. FIG. 6(b) illustrates a schematic representation of reducing reflectance losses by reducing the reflective index mismatch between the luminescent particle and surrounding medium by coating the luminescent particle with a surfactant.

FIG. 7 illustrates the optical efficiency and reflectance relationships with refractive index differences, Δn.

### DETAILED DESCRIPTION OF PREFERRED EMBODIMENTS

The present invention provides compositions comprising luminescent particles coated by surface capping agents. In certain embodiments, the luminescent particles include organic phosphors, inorganic ceramic materials doped with optically-active ions (i.e., rare earth doped phosphors), and semiconductor quantum dots. The brightness (i.e., emission intensities) and energy efficiency of phosphors are important performance characteristics that determine the suitability of such phosphors for use in various application, including, but not limited to, light emitting devices, illuminators, solid state lasers, solar harvesting devices, displays, tracers for the study of flow patterns (e.g., imaging velocimetry), and contrast agents for disease monitoring. For example, brighter and more efficient phosphors improve the diagnostic sensitivity of biomedical phosphor probes and enhance the energy efficiency of phosphor-based illuminators.

Applicants have recognized a need in the art for increasing the efficiency of luminescent materials by reducing the refractive index mismatch between the light-emitting phosphor core and surrounding medium. Applicants have surprisingly found that surfactants and surface coatings have a positive impact on optical efficiency of luminescent particles, and in particular infrared-to-visible upconversion rare earth doped phosphor microparticles. Surfactants, surface-active agents are often added to control particle size and particle morphology, as well as modulate the dispersion of these particles. These surfactants are expected to affect optical performance and efficiency by attenuating either the excitation or emission light. The alkyl (—CH₂) and hydroxyl (—OH) groups on surfactants inactivate surface rare earth ions and quench any emissions from nanoparticles. Applicants have surprisingly found, however, that the contribution of surface quenching effects from these surfactants is minimized by using larger micron-sized particles where the percentage of surface atoms per particle (<<10%) is negligible.

### Luminescent Particles

Luminescence is emission of light by a substance not resulting from heat and is thus a form of cold body radiation. It can be caused by chemical reactions, electrical energy, subatomic motions, or stress on a crystal. Luminescent particles can be broadly classified as organic phosphors, inorganic ceramic materials doped with optically-active ions, and semiconductor quantum dots with size-dependent quantum confined states (or band gaps). Examples of semiconductor quantum dots include but are not limited to the following: PbS, PbSe, InP, InAs, CdS, CdSe, ZnS and ZnSe. The optically-active ions in doped inorganic ceramic materials possess energy levels that can be populated by direct excitation or indirectly by energy transfer to emit emissions at specific wavelengths. For example, rare earth ions are commonly doped in various ceramic hosts where the optical transitions are governed mainly by radiative transitions between energy levels of the 4f electrons that are shielded by 5s and 5p electrons. Suitable host compounds, rare earth dopants and methods of making phosphor compounds are disclosed by U.S. Pat. Nos. 6,699,406 and 7,094,361. In certain embodiments, suitable host compounds include, for example, NaYF₄, LaF₃, YF₃, CeF₃, CaF₂, CsCdBr₃, and Y₂O₃. In certain embodiments, suitable rare earth dopants include Ce, Pr, Nd, Sm, Eu, Gd, Tb, Dy, Ho, Er, Tm, and Yb. Furthermore, combinations of more than two or more rare earth dopants can be used, which include without limitation Nd—Tm, Yb—Er, Yb—Tm, Yb—Pr, Yb—Ho, Yb—Er—Tm, Yb—Pr—Tm—Er, Yb—Ho—Pr, and Yb—Ho—Tm. The absorption and emission properties of rare earth doped phosphors can be tailored by controlling the local environment, such as site symmetry, crystal field strength and electron-phonon interaction strength of rare-earth dopants. Halide hosts, including, but not limited to, NaYF₄, YF₃, and LaF₃, are favored for their low phonon energies which minimize non-radiative losses to enable intense up-converting emissions. These rare earth doped ceramic particles can have either of the following morphologies: spheres, rods, tubes, prisms, platelets, fibers and cubes over a wide range of length scales, including, but not limited to, nano-, micro- and macroscales.

The refractive index mismatch of the luminescent particles and surrounding medium can be a function of mono-dispersed particles or agglomerated particles, and will depend on the choice of the host. In certain embodiments, the mono-dispersed or agglomerated particle has a size ranging from about 10 nanometers to about 1 millimeter. In certain other embodiments, the mono-dispersed or agglomerated particle has a size ranging from about 100 nanometers to about 1 micron.

Amongst the various fluoride hosts, Applicants have found that low phonon energy hexagonal-phase NaYF₄ doped with either Yb—Er or Yb—Tm trivalent rare earth ions is one of the most efficient host for the infrared-to-visible upconversion process. Besides the low phonon energy host, the high upconversion efficiency has been attributed to the multisite character of the hexagonal-phase NaYF₄ crystal lattice, where the rare earth active center may occupy two or three non-equivalent sites. Yb³⁺ ions are added to serve as a sensitizer that enhances the infrared-to-visible upconversion efficiency due to the strong energy transfer from Yb³⁺ to neighboring Er³⁺ (or Tm³⁺) ions.

### Surface Capping Agents

Surface modification of nanoparticles is often required to improve its stability, compatibility and functionality. Surfactants, surface-active agents, have been used to engineer the surface characteristics of nanoparticles to improved particle stability and functionality. Some surfactants commonly used are macromolecules (e.g. deoxyribonucleic acid, ribonucleic acid, proteins, glycoproteins), polypeptides, polysaccharides or polymers. Examples of suitable macromolecules, polypeptides, polysaccharides or polymers can include but are not limited to the following, such as poly-L-lysine, poly-d-lysine, poly-ethylene glycol [PEG], poly-2-hydroxyethyl aspartamide, poly(d,l-lactide-co-glycolide) [PLGA], poly(methyl methacrylate) [PMMA], poly(N-isopropylacrylamide), poly(amidoamine) [PAMAM], polyethyleneimine, poly lactic acid, polycaprolactone, dextran, alginates, chitosan, transferrin, collagenase and gelatin. The macromolecules, polypeptides, polysaccharides or polymers are attached to particles through either physical or chemical bonds (e.g. covalent, van der Waals, ionic, electrostatic, hydrogen bonds). In certain preferred embodiments, suitable surface capping agents include trioctylphosphine, polyethylene glycol monooleate, polyvinyl-pyrrolidone, polyvinyl-alcohol, polyethylene glycol dioleate, polyol esters, oleic acid, and oleylamine.

Encapsulation techniques can include coacervation, coprecipitation, solvent evaporation, interfacial polymerization, emulsion, and hot melt processes. The method of executing the formulation is crucial to the final composite properties and function. Surfactants enhance nanoparticle stability through the reduction of surface energy, and by acting as a barrier to agglomeration through either steric hindrance or repulsive electrostatic forces. Parameters that will affect the dispersion or solubility of these surface-capped particles are the chemical functional groups, hydrophilicity and surface charge. In addition, the surface-capped particle size can be varied by controlling the surfactant coating to affect the transport properties (e.g., biodistribution, clearance or airborne behavior of aerosols). These surface-capped particles can be of different length scales, including, but not limited to, nano- and microscales, and morphologies, including, but not limited, to spheres, rods, platelets, prisms, cubes, and acicular. In certain embodiments, the surface-capped particles (including surface-capped mono-dispersed particles and agglomerated particles) have a size ranging of from about 10 nanometers to about 1 millimeter. In certain other embodiments, the surface-capped particles (including surface-capped mono-dispersed particles and agglomerated particles) have a size ranging of from about 100 nanometers to about 1 micron.

One of ordinary skill in the art guided by the present specification will understand that scope of the present invention extends to essentially any surfactant that will control the refractive index mismatch between luminescent particles and the medium into which they emit light, typically air. The emitted light can be UV, visible or infra-red wavelengths, or a combination thereof. The present invention can be practiced by coating essentially any luminescent particle having a refractive index mismatch with the medium into which it emits light. While not wishing to be bound by theory, the difference in efficiency of unmodified luminescent particles as compared against surface-capped luminescent particles can be attributed to reduced reflectance losses at the interface of the luminescent particle and surrounding medium via refractive index mismatch reduction between the luminescent particles and surrounding medium. In certain preferred embodiments, the refractive index mismatch of surface-capped particles and the surrounding medium is less than about 0.1, preferably less than about 0.01, and even more preferably less than about 0.001.

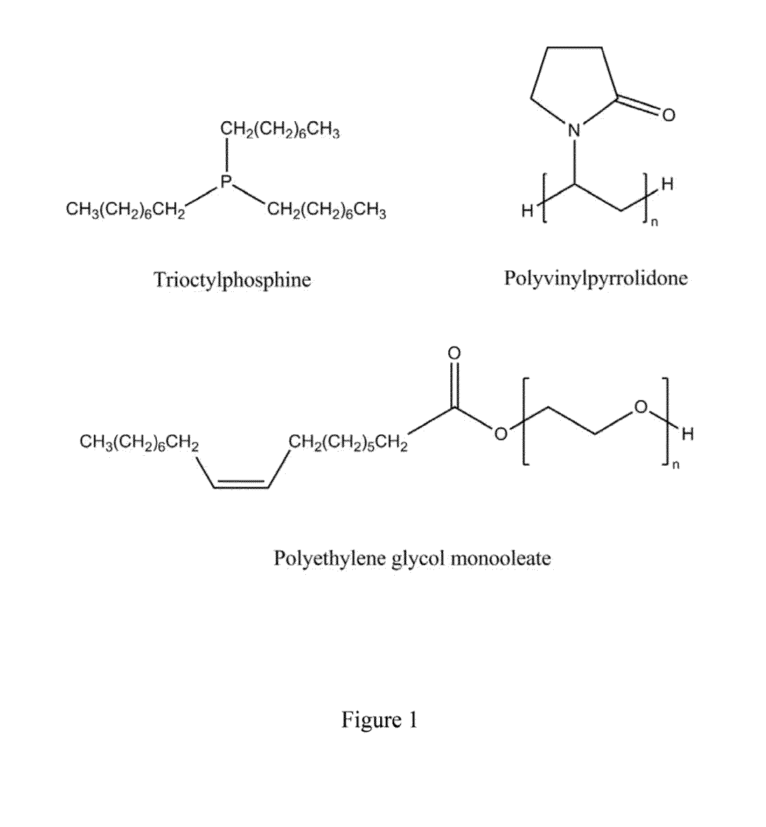

In certain embodiments of the present invention, the luminescent particles include infrared-to-visible rare earth doped upconversion phosphors that convert multiple photons of lower energy to higher energy photons offer a wide range of technological applications. Certain preferred embodiments of the present invention provide hexagonal-phase NaYF₄:Yb—Er synthesized using the hydrothermal method in the presence of surfactants. In certain preferred embodiments, such surfactants include trioctylphosphine, polyethylene glycol monooleate, and polyvinylpyrrolidone, among others. The molecular structures of each of these surfactants are shown in FIG. 1 and are known to physisorb on the surfaces of a wide range of particles. Optical efficiency can be used as a measure of the upconversion emission performance of these rare earth doped phosphors. As described in further detail below, the optical efficiency of upconversion emissions for surface-modified NaYF₄:Yb—Er were measured to quantitatively evaluate the effects of surfactants on the brightness and energy efficiency of these phosphors. Applicants have surprisingly found that polyvinyl-pyrrolidone-modified NaYF₄:Yb—Er particles are about five times more efficient and brighter than the unmodified particles.

### Light Emitting, Displays, and Solar Devices

Luminescent devices assembled from the surface-capped luminescent particles of the present invention are also novel and non-obvious, and meet the need for articles with luminescent properties that structured so as not to interfere with the optical properties of the devices in which they are employed. Surface-capped luminescent particles can be employed to produce a variety of useful articles with valuable optical properties. The surface-capped luminescent particles can be readily processed by conventional techniques to yield optical fibers, bulk optics, films, monoliths, and the like. Optical applications thus include the use of the surface-capped luminescent particles to form the elements of zero-loss links, upconversion light sources, standard light sources, volumetric displays, flat-panel displays, sources operating in wavelength-division-multiplexing schemes and the like.

In certain aspects, the present invention provides surface-capped luminescent particles used as part of or in conjunction with solid state lighting (e.g., light emitting devices, illuminators), solid state lasers, solar harvesting devices and displays. In certain embodiments, the luminescent particles suitable for use in such applications comprise rare earth doped ceramics and quantum dot semiconductors. The emission efficiency (e.g., optical efficiency, external quantum efficiency) of the luminescent particles is critical to the performance of these devices and will limit the impact of technological advancements for the above-mentioned applications. Processing of the luminescent particles is often required to allow: (1) adhesion of powders on the windows of illuminators or light emitting devices to control wavelength of emitted light; (2) incorporation of powders with polymer or ceramic matrices to create structures that form part of the device (e.g., optical fibers or display windows); and (3) improved mixing of powders of different physical properties (e.g., particle size). Currently, the selection of a suitable surfactant is based on its function in improving the dispersion or adhesive properties of the luminescent particles (e.g., powder mixedness and composite uniformity). One of ordinary skill in the art guided by the present specification will understand that emission intensity from the luminescent particles and device performance can be improved by reducing the refractive index mismatch between the particles and surrounding medium to reduce reflectance losses.

### Particle Imaging Velocimety

Certain aspects of the present invention provide surface-capped luminescent particles for use in conjunction with particle imaging velocimetry. Flow visualization or measurement of fluid velocity is required to understand flow problems (e.g, flow over an aircraft wing, blood around prosthetic heart valves) and to enable the design and engineering of better products. For example, fuel efficient vehicles due to better aerodynamics, and prosthetic heart valves that prevents biofouling caused by flow conditions. Optical methods (e.g., particle imaging velocimetry) are amongst the most commonly used to experimentally validate computational flow models. The tracer or seeding particles are a critical component of any particle imaging system where the particles must be able to match the fluid properties so as to follow the flow satisfactorily enough for the analysis to be considered accurate. Luminescent tracers are commonly used to monitor various flow patterns (e.g., blood flow, leaks from sealed vessels) as it allows an improvement in the accuracy of flow velocity measurement since selectively observe the fluorescent emissions of the tracer particles can be made without the influence of the exciting light by using a filter. It is particular advantageous for a mixed fluid system consisting of two or more different fluids, where the flow and mixing behavior of each fluid can be observed by using a different tracer particles. For an accurate measurement, the brightness and transport behavior of these luminescent materials will be very important. One of ordinary skill in the art guided by the present specification will be able to determine the right surfactants that enable both bright emissions from reduced losses from refractive index mismatch and an accurate match to fluid properties for accurate flow simulation (i.e., good dispersion in air or fluid of choice).

### Contrast Agents for Disease Monitoring

Certain aspects of the present invention provide surface-capped luminescent particles for use as part of or in conjunction with contrast agents for disease monitoring. Chemical conjugation of nanoparticles with biomolecules such as therapeutic agents, targeting peptides or antibodies can be enabled by the presence of functional groups (e.g., carboxyl or amine groups) on surfactants. The incorporation of the unique properties of nanoparticles has expanded alternative biomedical platforms for various applications, including drug delivery systems, diagnostic imaging and molecular and sensing devices. Examples of targeting ligands can include, but are not limited to the following: (1) Herceptin that preferentially binds to the HER2/neu and folate receptors; and (2) Glutamic acid-Proline-Proline-Threonine (EPPT) peptide that preferentially hinds to underblycosylated MUC-1 tumor antigen (uMUC-1), which is a common feature of numerous epithelial cell adenocarcinomas of breast, pancreas, colon/rectum, lungs, prostate, and stomach. The adaptability of the ligand or antibody conjugation procedure means that the type, number and combinations of targeting moieties on the surface of can be modified easily, further improving their tumor localization and influencing their biodistribution. The tunability, brightness, and energy efficiencies of luminescent nanomaterials are important performance parameters for biomedical applications like real time disease monitoring, diagnostic biomedical imaging and theranostics. In this applications example, surfactants with the right functional groups to enable coupling to various biomolecules and low refractive index mismatch is required to enable bright emissions from the luminescent contrast agent.

The following examples are provided to further illustrate the methods and compositions of the present invention. These examples are illustrative only and are not intended to limit the scope of the invention, in any way.

### EXAMPLES

### Example 1

### Hydrothermal Synthesis of NaYF₄:Yb—Er Upconversion Phosphors

Stoichiometric amounts of rare earth nitrates (Sigma Aldrich, St. Louis, Mo.) were mixed with 1.5 times excess sodium fluoride in about 70 mL of water:ethanol mixture (80:20 v/v) and various additives for 30 min to synthesize NaY_{0.78}Yb_{0.20}Er_{0.02}F₄ particles. 2×10⁻⁴; moles which corresponds to 0.1 mL, 0.1 mL and 8 g of trioctylphosphine, polyethylene glycol monooleate (PEG monooleate, average Mₙ of about 460 g/mol) and polyvinylpyrrolidone (average Mₙ of about 40,000 g/mol), respectively from Sigma Aldrich was added to the reaction mix. This mixture was next transferred to a 125 mL. Teflon liner and heated to about 240° C. for 4 h in a Parr pressure vessel (Parr Instrument Company, Moline, Ill.). The as-synthesized particles were washed three times in deionized water by centrifuging (Beckman-Coulter Avanti J-26 XP, Fullerton, Calif.) and dried at 70° C. in air in a mechanical convection oven (Thermo Scientific Thermolyne, Waltham, Mass.) for further powder characterization.

### Example 2

### Powder Characterization by X-ray Diffraction

Powder x-ray diffraction (XRD) patterns were obtained with a resolution of 0.04°/step and 2 sec/step with the Siemens D500 (Bruker AXS Inc., Madison, Wis.) powder diffractometer (40 kV, 30 mA), using Cu K_{α} radiation (μ=1.54 Å). Powder diffraction files (PDF) from International Centre for Diffraction. Data (ICDD, Newtown Square, Pa.) PDF#97-005-1917 for hexagonal NaYF₄ was used as reference.

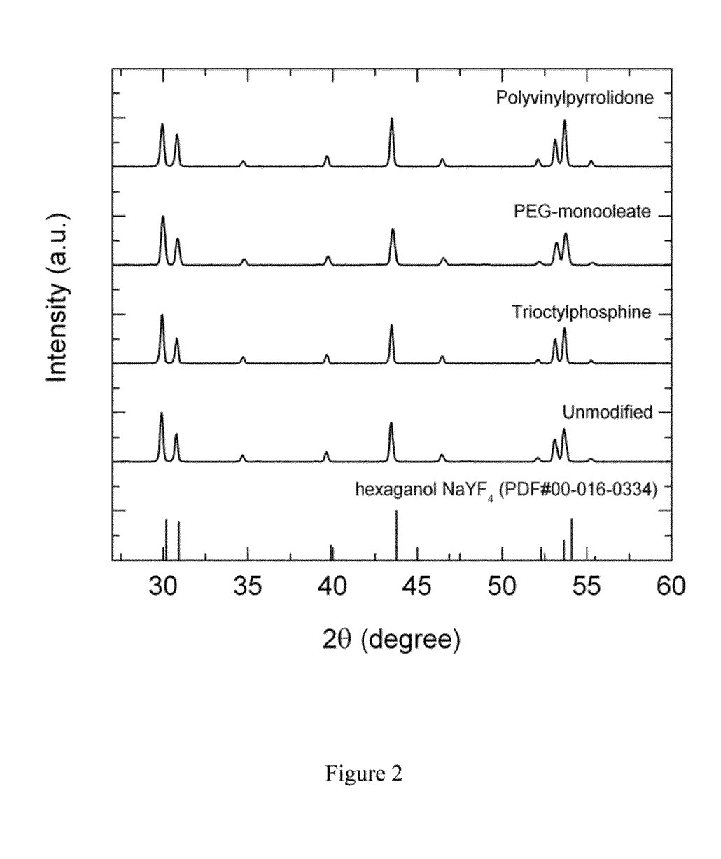

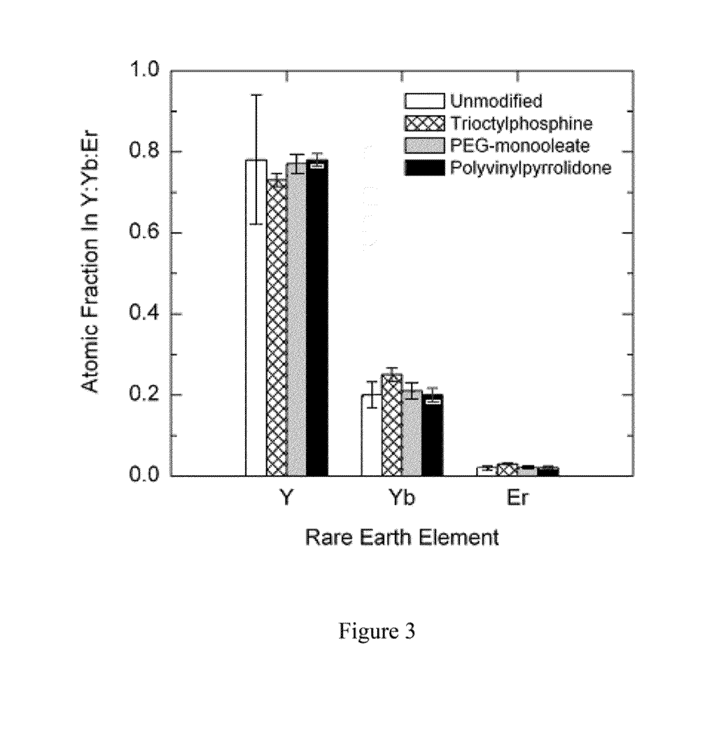

From the XRD profiles as shown in FIG. 2, pure hexagonal-phase NaYF₄:Yb—Er powders were synthesized using the hydrothermal method and different surfactants. No statistically significant difference in grain sizes were observed based on the full width at half maximum of the various diffraction peaks for the different powders. Using the Scherrer equation, the average grain size estimated for each of the different powders shown in FIG. 2 was about 41±5 nm. Since the concentration of rare earths in the host lattice has a significant effect on the emission intensities of these upconversion phosphors, it is critical to ensure the uniform precipitation of rare earth dopants (i.e. Y, Yb and Er). No difference was observed in elemental composition measured using EDX for NaYF₄:Yb—Er synthesized with and without the addition of surfactants (FIG. 3). Thus, the presence of the surfactants did not have a deleterious effect on the homogenous nucleation from solution.

### Example 3

### Powder Characterization by X-ray Photoelectron Spectroscopy

X-ray photoelectron spectroscopy (XPS) measurements were performed using XSAM 800 KRATOS apparatus with a 127 mm radius concentric hemispherical analyzer (CHA). An Al Kα radiation with a photon energy of 1486.6 eV was used as x-ray source; and photoelectrons were detected by the CHA operated in the fixed retarding ratio mode FRR5 (survey scans), and in the fixed analyzer transmission modes FAT20 or FAT40 (detail scans) with the pass energies of 20 and 40 eV, respectively, XPS quantification of the atomic fraction for each component was determined by comparing relative intensities of photoelectron peaks together with the corresponding sensitivity factors, and assuming their total intensities to be 100%. The atomic fraction was subsequently normalized to the integrated intensity of Na (2s) peaks to allow for comparisons between samples. The measurements were performed under UHV conditions with a residual pressure of about 10⁻⁹ Torr. For destructive depth profiling, etching of powder samples was conducted by sputtering in an Ar atmosphere at 3 keV and 3 μA/cm² for 15 min.

The surface areas of as-synthesized particles were estimated to be ˜(0.4-0.7 m²/g, by assuming particle rod morphologies and density of 4.23 g/cm³ (i.e. hexagonal phase NaYF₄). Based on theoretical calculations, about 6×10⁻⁷ wt % of surfactants were estimated to be adsorbed on the particles, by taking into consideration a 10 nm thick surfactant coating and surfactant density of 1.2 g/cm³. The low surface area and surfactant content led to difficulties in obtaining Fourier transform infrared spectra of the surface-modified particles and quantifying the surfactant content using thermal gravimetric methods. Therefore, the presence of the surfactants on as-synthesized. NaYF₄:Yb—Er was evaluated using the XPS techniques (Table 1). For the unmodified particles, about 5 at/at of carbon was observed. The carbon that was detected on the unmodified particles was from residual environmental carbon sources (e.g., dust, residual organics, adhesive) that was either in the chamber or on the sample.

The increased carbon content of about 8-10 at/at on the surface modified NaYF₄:Yb—Er compared to unmodified NaYF₄:Yb—Er particles verified the presence of the surfactants on the particles. The carbon content was reduced to about 3-4.5 at/at after the removal of the surface layers by sputtering the sample in Ar for about 15 min. Therefore, the surfactants were most likely coated on the surfaces of as-synthesized NaYF₄:Yb—Er particles. Considering that the boiling temperatures were 250, 260 and 290° C. for polyvinylpyrrolidone, PEG monooleate and trioctylphosphine, respectively, it was unlikely that these surfactants were degraded during the hydrothermal synthesis of NaYF₄:Yb—Er particles. In addition, the Y:(Yb—Er) atomic ratios of about 0.78:0.22 determined from the XPS results in Table 1, as shown below, were consistent with atomic ratios determined using EDX in FIG. 3. The XPS and EDX results indicated that the rare earths were relatively uniformly distributed within the NaYF₄ microparticles.

TABLE 1
XPS data showing surface hydrocarbon content for as-synthesized particles.

| Element | Unmodified | | Trioctylphosphine | | PEG-monooleate | | Polyvinylpyrrolidone | |
|---|---|---|---|---|---|---|---|---|
| (at %/Na at %) | 0 min | 15 min | 0 min | 15 min | 0 min | 15 min | 0 min | 15 min |
| Y (3d) | 0.91 | — | 0.96 | — | 0.91 | — | 0.85 | — |
| Yb (4d) | 0.26 | — | 0.29 | — | 0.32 | — | 0.23 | — |
| Er (4d) | | | | | | | | |
| C (1s) | 5.25 | 4.02 | 7.66 | 3.17 | 7.49 | 4.39 | 10.23 | 3.54 |
| Na (2s) | 1.00 | 1.00 | 1.00 | 1.00 | 1.00 | 1.00 | 1.00 | 1.00 |

### Example 4

### Powder Characterization by Scanning Electron Microscopy

Scanning electron microscopy (SEM) images of the powder samples were taken using the Carl Zeiss sigma field emission scanning electron microscope (Carl Zeiss, Carl Zeiss SMT Inc., Peabody, Mass.) using the secondary electron detector and operating at an accelerating voltage of 5.0 kV with working distance of 10 mm. Primary particle sizes and aspect ratios from SEM micrographs were evaluated using the digital image processing and analysis software, IMAGEJ. Particle morphology was poorly fitted to a rectangle using IMAGEJ software, However, the results generated using IMAGEJ by fitting particle area to a rectangle shape were sufficient to give a qualitative determination of particle morphology changes. Results generated from the software were manually verified by selecting and measuring approximately ten random particles from each micrograph. Energy-dispersive x-ray (EDX) spectroscopy area scans of the powder samples were also completed to determine its elemental composition by increasing the accelerating voltage to 25 kV and reducing the working distance to 8.5 mm for an aperture of 30 μm. The EDX elemental composition was determined by comparing relative peak intensities together with the corresponding sensitivity factors of each element, and assuming their total intensities to be 100%.

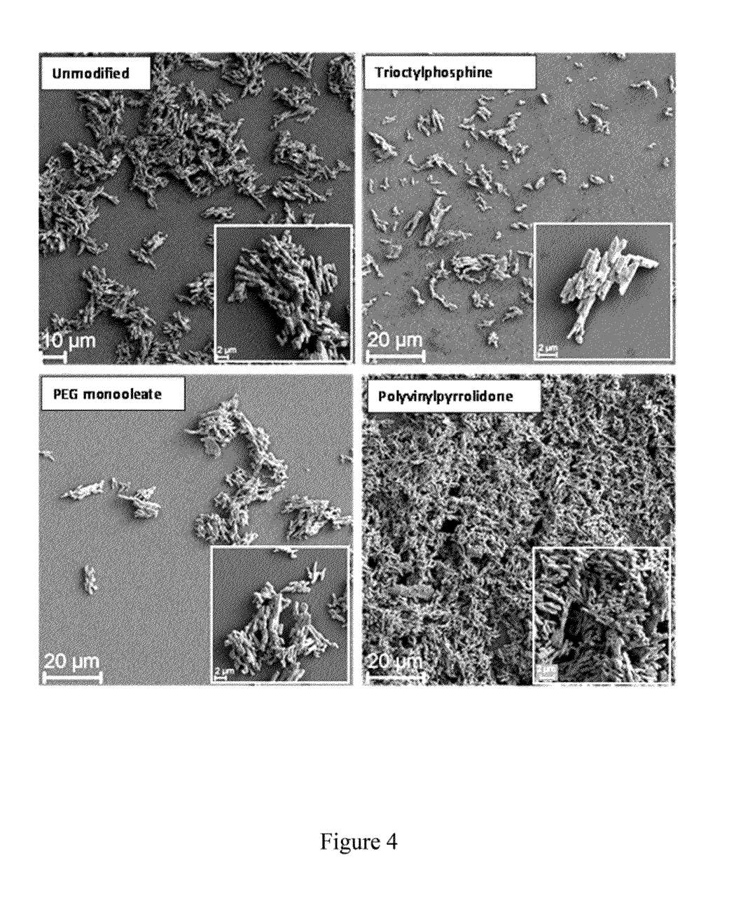

SEM micrographs show that irregular, elongated micron-sized NaY₄:Yb—Er particles were prepared using the different surfactants, and are illustrated in FIG. 4. Distribution of major axis of particle sizes for unmodified, trioctylphosphine-, PEG monooleate-, polyvinylpyrrolidone-modified particles were 2.74±0.56, 2.20±0.72, 2.81±0.69, 2.37±0.59 nm, respectively. Distribution of minor axis of particle sizes for unmodified, trioctylphosphine-, PEG monooleate-, polyvinylpyrrolidone-modified particles were 0.74±0.19, 0.78±0.17, 0.86±0.12, 0.76±0.24 μm, respectively. No difference in particle morphology was observed for the NaYF₄:Yb—Er particles synthesized with and without the addition of surfactants. No statistically significant difference in particle sizes was observed for all NaYF₄:Yb—Er particles synthesized with and without the addition of surfactants, Broad particle size distributions were obtained in all cases, where the range of particles' lengths and widths were about 2-4 and about 0.5-0.9 μm, respectively. Since particle size and morphology was not observed to be significantly different, we concluded that the surfactants did not play a dominant role in controlling the mechanisms for particle growth. Furthermore, the difference in particle sizes and grain sizes indicates that polycrystalline NaYF₄:Yb—Er particles were synthesized.

### Example 5

### Optical Emission Measurements

The phosphor powder samples were packed in demountable Spectrosil® far UV quartz Type 20 cells (Starna Cells. Inc, Atascadero, Calif.) with 0.5 mm path lengths for optical emission measurements. The optical emission spectra of nanoparticles excited at −976 nm with a 2.5 W laser (BW976, BW Tek, Newark, N.J.), was collected using the FSP920 Edinburgh Instruments spectrometer (Edinburgh Instruments, Livingston, United Kingdom) that was equipped with a Hamamatsu R928P photomultiplier tube detector.

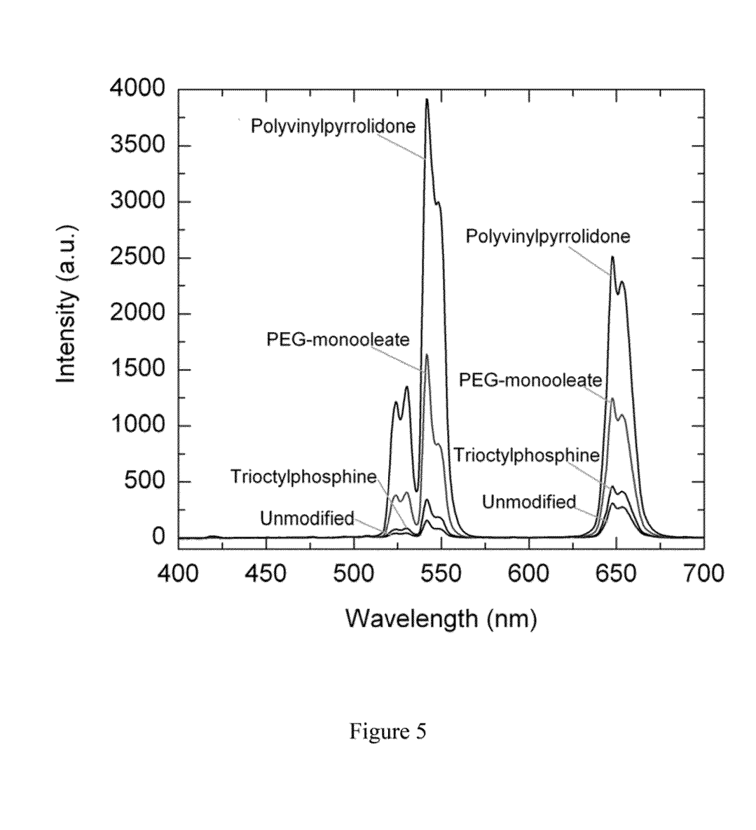

The upconversion emission spectra of various surface-modified NaYF₄:Yb—Er particles as dried powders were collected. Several difficulties were encountered during the collection of particles suspended in various liquids (e.g., water, isopropanol). The rapid settling of the micron-sized particles in solution and large scattering losses from both the liquid medium and large particle sizes will lead to many inconsistencies in the emission spectra collected from the particle suspensions. FIG. 5 shows the upconversion emission spectra of the various surface-modified NaYF₄:Yb—Er particles. Distinct differences in emission intensities as-synthesized NaYF₄:Yb—Er powders were observed.

All surface modified particles were found to have more intense emissions than the unmodified. NaYF₄:Yb—Er particles. Polyvinylpyrrolidone-modified NaYF₄:Yb—Er particles exhibited the most intense emissions. The ranking for the emission intensities was: polyvinylpyrrolidone>PEG monooleate>trioctylphosphine>unmodified phosphor particles. The upconversion performance of these phosphors was subsequently quantified and evaluated by measuring the optical efficiency of the 550 nm emission (Table 2). The measured values were in the same order of magnitude to that of the conversion, or radiant efficiency values of 10⁻³ to 10⁻⁴ that was previously reported for upconversion phosphors. The polyvinylpyrrolidone-modified NaYF₄:Yb—Er particles was found to be about 5 times more efficient and brighter than the unmodified particles. Furthermore, the ranking in the optical efficiencies was consistent with observations made from the emission spectra in FIG. 5.

### Example 6

### Optical Efficiency Measurements

In certain preferred embodiments, the luminescent particles of the present invention include infrared-to-visible rare earth doped upconversion phosphors that convert multiple photons of lower energy to higher energy photos. Radiant efficiency, the ratio of emitted power to absorbed power was used to measure the emission intensity and brightness of the different upconversion phosphors. Efficiencies in the range of 10⁻³ to 10⁻⁴ are reported for most upconversion phosphors. However, the approach for evaluation of phosphor performance leads to significant measurement errors. The relatively low rare earth concentrations (<2 mol %) leads to low absorption cross sections (typically of the order from 1×10⁻²¹ to 5×10⁻²⁰ cm²). Low absorption in conjunction with scattering and reabsorption losses are not properly accounted for in computing radiant efficiency. Since optical efficiency is the ratio of emitted power to incident power, this approach circumvents the absorption measurement related errors. However, optical efficiency can be used as a measure of the upconversion emission performance of rare earth doped phosphors.

For the optical efficiency measurements, powder samples of as-prepared phosphors were dry pressed into pellets of 1 cm diameter and 2 mm thickness. A modification of the C9220-03 quantum yield measurement system from Hamamatsu (Hamamatsu, Bridgewater, N.J.) was used to make the optical efficiency measurements. In brief, the measurement principle is based on direct illumination and indirect reflection. Light enters the integrating sphere through the sample port, goes through multiple reflections and is scattered uniformly around the interior of the sphere. For our measurements, the integrating sphere was set up in the reflectance mode to measure total integrated reflectance of a surface. The PD300-IR and PD300-UV power detectors (Ophir-Spiricon, Logan, Utah) which measures the power of emitted light was used in place of the photomultiplier tube that was originally on the C9220-03 quantum yield measurement system, it was positioned at the port at the side of the sphere where the emitted beam is independent of the angular properties of light at the sample port. A further assumption made during measurements is that all light emanating from the different samples is isotropic.

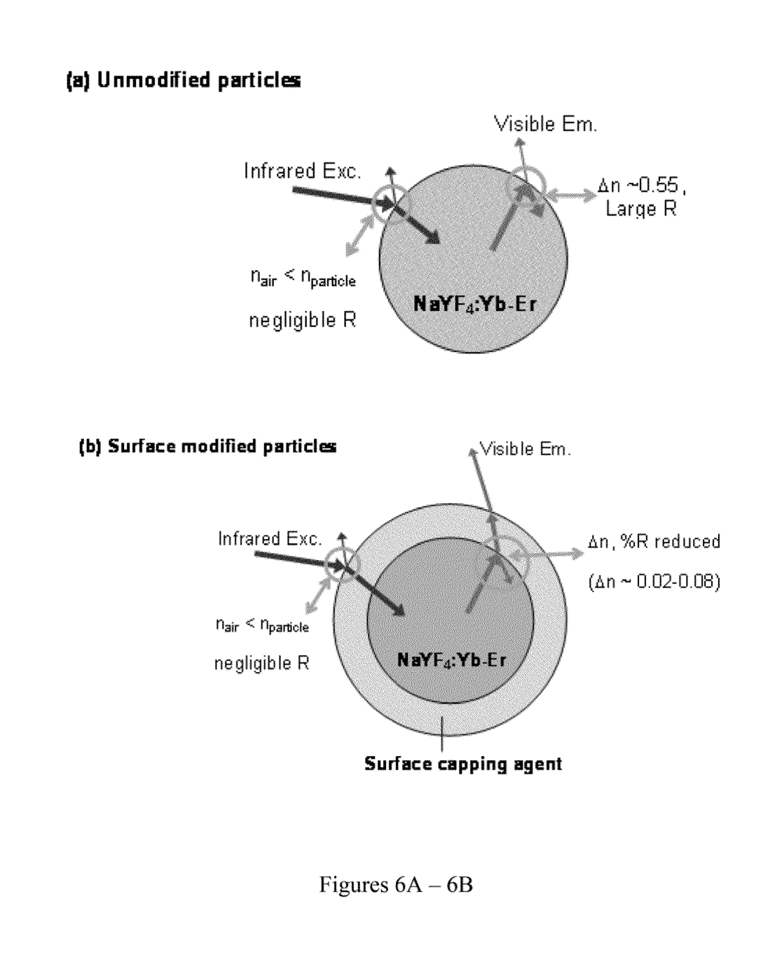

The differences in optical efficiencies for the different surface-modified NaYF₄:Yb—Er particles were attributed to the reduction in reflectance losses at the particle-air interface. Fresnel reflection (i.e., principle for total internal reflection) occurs at any medium boundary where the refractive index changes from low to high, resulting in a portion of light being reflected back (see FIG. 6). The reflectance loss of the incident infrared excitation light was negligible since the refractive index of air is less than that of NaYF₄:Yb—Er phosphor particles. The reflectance at the boundary, R can be estimated using the following equation.

$$R ( \% ) = \frac{{( {n}_{1} - {n}_{2} )}^{2}}{{( {n}_{1} + {n}_{2} )}^{2}} \times 100 \%$$

where n₁ and n₂ are the refractive indices of the core light-emitting NaYF₄:Yb—Er phosphor particles and surrounding medium (i.e. air or surface capping agents), respectively.

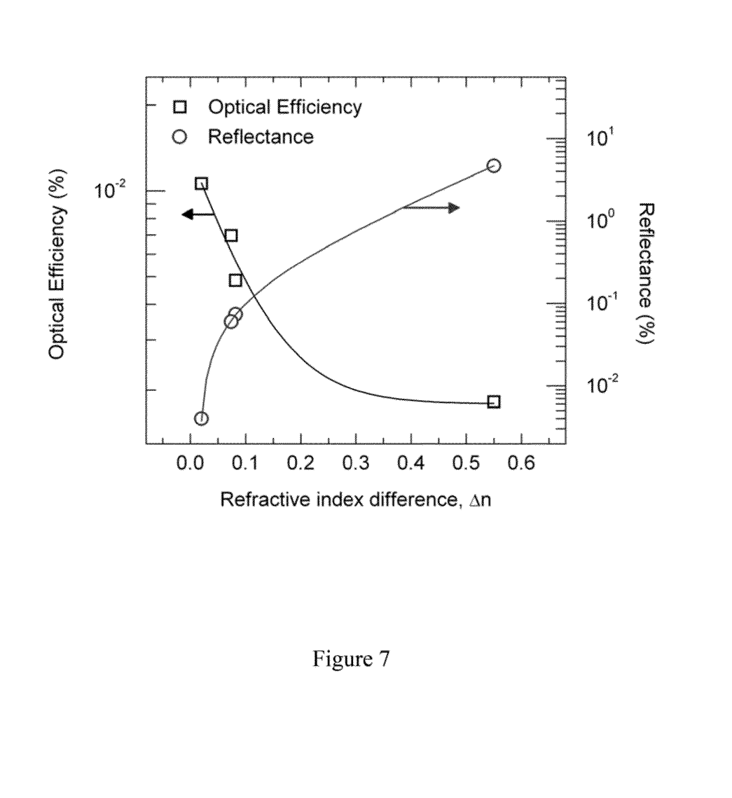

The large refractive index mismatch between the core NaYF₄:Yb—Er and surrounding medium leads to high reflectance losses of the emitted light (Table 3 and FIG. 7). The portion of emitted light that is back reflected is most likely reabsorbed. While some of the reabsorbed light is re-emitted, another fraction of the reabsorbed portion is lost through either lower photon energy or non-radiative emissions. Consequently, the high reflectance loss leads to significant reduction of emitted light from the light-emitting NaYF₄:Yb—Er core. The reduction of emitted light from the as-synthesized unmodified NaYF₄:Yb—Er powders results in lower measured optical efficiency values, as demonstrated in Table 2 below and FIG. 7.

TABLE 2
Optical efficiency of 550 nm emission using an incident
power of 0.330 mW for the 975 nm excitation.

| | Emitted Power (nW) | Optical Efficiency (%) |
|---|---|---|
| Unmodified | 6 | 0.00182 |
| Trioctylphosphine | 16 | 0.00485 |
| PEG-monooleate | 23 | 0.00697 |
| Polyvinylpyrrolidone | 35 | 0.01061 |

The reflectance losses is lowered by reducing the refractive index mismatch between the core NaYF₄:Yb—Er particles and surrounding medium through the use of surfactants, as shown in Table 3 below.

TABLE 3
Reflectance loss (from back reflections) at
interface due to refractive index mismatch.

| | Refractive Index, n | n₁ − n₂ | Reflectance (%) |
|---|---|---|---|
| Unmodified (air) | 1.000 | 0.550 | 4.652 |
| Trioctylphosphine | 1.468 | 0.082 | 0.074 |
| PEG-monooleate | 1.476 | 0.074 | 0.060 |
| Polyvinylpyrrolidone | 1.530 | 0.020 | 0.004 |
| NaYF₄ | 1.550 | — | — |

The gradual reduction in refractive index mismatches by using surfactants across the particle surface-air interface has reduced the reflectance and re-absorption losses of emitted light. The reduced losses ultimately increase the optical efficiencies for surface-modified NaYF₄:Yb—Er particles, as indicated in Table 2 above.

Accordingly, the above examples demonstrate that the use of different surface capping agents significantly changes the optical efficiency of as-synthesized NaYF₄: Yb—Er particles. The polyvinyl-pyrrolidone-modified NaYF₄:Yb—Er particles was found to be about 5 times more efficient and brighter than the unmodified particles. As demonstrated by the above example, the brightness and efficiency ranking of the example surfactants is polyvinyl-pyrrolidone>PEG monooleate>trioctylphosphine>unmodified particles. The difference in efficiency was attributed to reduced reflectance losses at the boundary by reducing the refractive index mismatch between the core NaYF₄ particles and surrounding medium by using polyvinylpyrrolidone as a surface coating agent.

What is claimed is:

1. A luminescent composition comprising one or more luminescent particles, wherein the luminescent particles are coated by a surface capping agent.

2. The composition of claim 1, wherein the luminescent particles are selected from the group consisting of rare earth doped phosphors, semiconductor quantum dots, organic phosphors, and combinations of two or more of these.

3. The composition of claim 1, wherein the luminescent particles comprise one or more rare earth doped phosphors comprising a host compound and a rare earth dopant.

4. The composition of claim 3, wherein the rare earth doped phosphors comprise a host compound selected from the group consisting of NaYF₄, LaF₃, YF₃, CeF₃, CaF₂, CsCdBr₃, Y₂O₃, and combinations of two or more of these.

5. The composition of claim 3, wherein the rare earth, doped phosphors comprise a rare earth dopant selected from the group consisting of Ce, Pr, Nd, Sm, Eu, Gd, Tb, Dy, Ho, Er, Tm, Yb, and combinations of two or more of these.

6. The composition of claim 3, wherein the rare earth doped phosphors comprise a dopant scheme of two or more rare earth dopants selected from the group consisting of Nd—Tm, Yb—Er, Yb—Tm, Yb—Pr, Yb—Ho, Yb—Er—Tm, Yb—Pr—Tm—Er, Yb—Ho—Pr, and Yb—Ho—Tm.

7. The composition of claim 1, wherein the luminescent particles comprise one or more semiconductor quantum dots selected from the group consisting of PbS, PbSe, InP, InAs, CdS, CdSe, ZnS, ZnSe, and combinations of two or more of these.

8. The composition of claim 1, wherein the surface capping agent comprises a surfactant selected from the group consisting of macromolecules, polypeptides, polysaccharides, polymers, and combinations of two or more of these.

9. The composition of claim 8, wherein the surfactant is a macromolecule selected from the group consisting of deoxyribonucleic acid, ribonucleic acid proteins, glycoproteins, and combinations of two or more of these.

10. The composition of claim 8, wherein the surfactant is selected from the group consisting of pol-L-lysine, poly-d-lysine, poly-ethylene glycol, poly-2-hydroxyethyl apartamide, poly(d,l-lactide-co-glycolide, poly(methyl methacrylate), poly(N-isopropylacrylamide), poly(admidoamine), polyethyleneimine, poly lactic acid, polycarpolactone, dextran, alginates, chitosan, transferrin, collagenase, gelatin, and combinations of two or more of these.

11. The composition of claim 8, wherein the surfactant is selected from the group consisting of trioctylphosphine, polyethylene glycol monooleate, polyvinyl-pyrrolidone, polyvinyl-alcohol, polyethylene glycol dioleate, polyol esters, oleic acid, olelamine, and combinations of two or more of these.

12. The composition of claim 8, wherein the luminescent particles are selected from the group consisting of rare earth doped phosphors, semiconductor quantum dots, organic phosphors, and combinations of two or more of these.

13. The composition of claim 12, wherein the luminescent particles comprise one or more semiconductor quantum dots selected from the group consisting of PbS, PbSe, InP, InAs, CdS, CdSe, ZnS, ZuSe, and combinations of two or more of these.

14. The composition of claim 12, wherein the luminescent particles comprise one or more rare earth doped phosphors comprising a halide host compound and a rare earth dopant.

15. The composition of claim 12, wherein the luminescent particles comprise one or more rare earth doped phosphors, each comprising a host compound selected from the group consisting of NaYF₄, LaF₃, YF₃, CeF₃, CaF₂, CsCdBr₃, Y₂O₃, and combinations of two or more of these, and one or more rare earth dopants selected from the group consisting of Ce, Pr, Nd, Sm, Eu, Gd, Tb, Dy, Ho, Er, Tm, Yb, and combinations of two or more of these.

16. A luminescent composition, wherein the luminescent composition comprises one or more luminescent particles comprising hexagonal phase NaYF₄ doped with Yb—Er, wherein the luminescent particles are coated by a surface capping agent composition comprising a surfactant selected from the group consisting of trioctylphosphine, polyethylene glycol monooleate, polyvinyl-pyrrolidone, and combinations of two or more of these.

17. The luminescent composition of claim 1, wherein the luminescent composition is in a surrounding medium consisting essentially of air.

18. The luminescent composition of claim 17, wherein the refractive index mismatch of the luminescent composition and the surrounding medium is less than about 0.1.

19. The luminescent composition of claim 17, wherein the refractive index mismatch of the luminescent composition and the surrounding medium is less than about 0.01.

20. The luminescent composition of claim 17, wherein the refractive index mismatch of the luminescent composition and the surrounding medium is less than about 0.001.
